(19) United States
(12) Patent Application Publication
(10) Pub. No.: US 2008/0151867 A1
(43) Pub. Date: Jun. 26, 2008

(54) Method and System for Routing of Media Signals

(75) Inventors: David C. Goodwin, Holland, PA (US); Thomas L. Du Breuil, Ivyland, PA (US); Peter A. Kindinger, Cary, IL (US); Mark A. Kolber, Churchville, PA (US); Anthony M. Radice, Chalfont, PA (US); Clyde N. Robbins, Maple Glen, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/614,458

(22) Filed: Dec. 21, 2006

(51) Int. Cl. H04L 12/66

(52) U.S. Cl. 370/352

(57) ABSTRACT

A video information appliance (104) for facilitating routing of a plurality of independent video signals is provided. The video information appliance includes a plurality of video signal input interfaces (202), a signal router (204), a plurality of video output ports (206) and a processor (208). Each of the plurality of video signal input interfaces is adapted to facilitate reception of the plurality of independent video signals. The signal router is coupled to the plurality of video signal input interface. The plurality of video output ports are coupled to the signal router. The processor is adapted to control the signal router to selectively direct at least one of the received independent video signals to at least a first video output port. The processor is also adapted to direct at least one other of the received independent video signals to at least a second video output port.

The present invention relates in general to video signals, and more particularly, to a method and system for routing the media signals.

### BACKGROUND OF THE INVENTION

In recent times, popularity of media content like broadcasted news, televised sports, music videos, has grown significantly. Subsequently, the number of media content providers has also grown exponentially. To provide the media contents to users, the media contents are encoded in video signals by the service providers. The video signals are broadcast by the service providers using different means. Some of the means used by service providers include over-the-air broadcasting, using television cables and satellite broadcasting. The video signals broadcast by the service provider have to be decoded before the users can view the media content. Different decoding devices used for this purpose include video tuners, video decoders and set top boxes. Once the media content has been decoded, it can either be viewed or recorded. Media appliances used for viewing and recording the media content include Digital Video Recorders (DVR), Television (TV) sets, Digital Video Disc (DVD) players/recorders, personal computers, Personal Digital Assistants (PDA's), cellular phones, and digital video cameras.

Traditionally, the broadcasting sources, the decoding devices and the media appliances are connected through wired links. These wired links reduces the flexibility of viewing and recording of various channels simultaneously. In addition, the wired links increases the complexity of the system.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments as well as explain various principles and advantages, all in accordance with the present invention.

FIG. 1 illustrates an exemplary media network, where various embodiments of the present invention can be practiced;

FIG. 2 illustrates a block diagram of a video information appliance, in accordance with an embodiment of the present invention; and

FIG. 3 illustrates a flow chart for routing a plurality of independent video signals within the video information appliance, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of embodiments of the present invention.

### DETAILED DESCRIPTION

Before describing in detail the particular method and system for routing of video signals, in accordance with various embodiments of the present invention, it should be observed that the present invention resides primarily in combinations of method steps for routing of video signals. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises”, “comprising”, or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element.

A “set”, as used in this document, means a non-empty set, i.e., comprising at least one member. The term “another,” as used in this document, is defined as at least a second or more. The terms “includes” and/or “having”, as used herein, are defined as comprising.

For an embodiment, a video information appliance for facilitating routing of a plurality of independent video signals is provided. The video information appliance includes a plurality of video signal input interfaces. Each of the plurality of video signal input interfaces is adapted to facilitate the reception of an independent video signal. Further, the video information appliance includes a signal router. The signal router is coupled to the plurality of video signal input interfaces. Furthermore, the video information appliance includes a plurality of video output ports. The plurality of video output ports are coupled to the signal router. In addition, the video information appliance includes a processor. The processor is adapted to control the signal router, in such a way that the signal router selectively directs at least one of the received independent video signals to at least a first video output port of the plurality of video output ports. The signal router further directs at least one other of the received independent video signals to at least a second video output port of the plurality of video output ports.

For another embodiment, a method for routing a plurality of independent video signals within a video information appliance is provided. The method includes receiving the plurality of independent video signals by a plurality of video signal input interfaces. Further, the method includes routing at least one of the received independent video signals to at least a first video output port of a plurality of video output ports. Furthermore, the method includes routing at least one other of the received independent video signals to at least a second video output port of the plurality of video output ports.

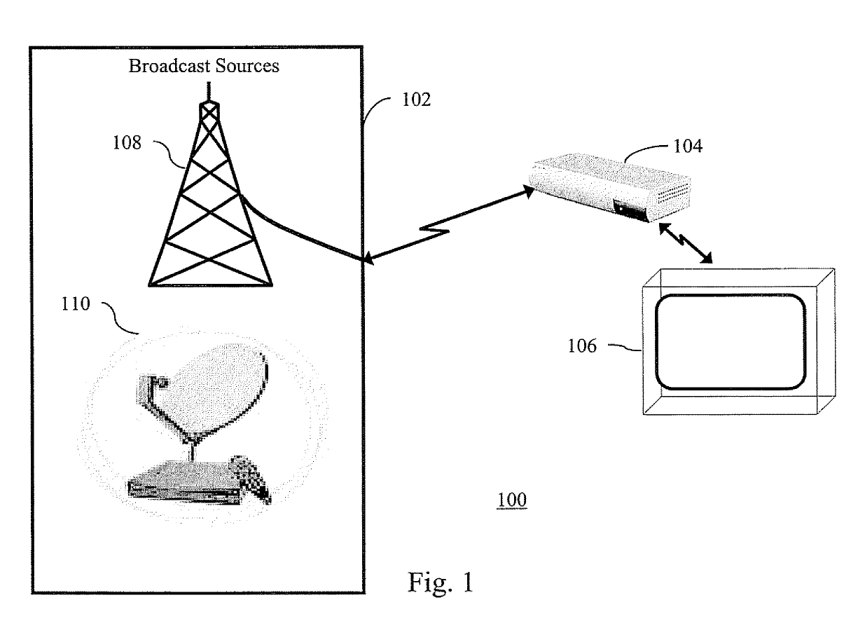

FIG. 1 illustrates an exemplary media network 100, where various embodiments of the present invention can be practiced. The media network 100 includes broadcast sources 102, a video information appliance 104, and an electronic device 106. The broadcast sources 102 transmit a plurality of independent video signals to the electronic device 106 through a video information appliance 104. The broadcast sources 102 further include a cable television signal source 108 and a satellite signal source 110. It will be apparent to one skilled in the art that the broadcast sources 102 is shown to include the cable television signal source 108 and the satellite signal source 110 for exemplary purposes only. The broadcast sources 102 can also include other sources like a media playback device source and an over-the-air broadcast television signal source. The cable television signal source 108 and the satellite signal source 110 are capable of broadcasting a plurality of independent video signals. Each of the plurality of independent video signals has a plurality of encoded media content. This plurality of encoded media content after processing provides a plurality of video channels. The plurality of video channels can be viewed or recorded on the electronic device 106. In other words the broadcast sources 102 (the cable television signal source 108 and the satellite signal source 110) are capable of transmitting a plurality of independent channels. For example CNN™ may be deliver over cable television signal source 108 and HBO™ may be delivered over satellite signal source 110. Continuing with our example, the broadcast sources 102 provides the plurality of independent channels, one of the plurality of independent channels will be provided from CNN while another one of the plurality of independent channels will be provided from Sky-television. The plurality of independent video signals transmitted by the cable television signal source 108 and the satellite signal source 110 are received by the video information appliance 104. Example of the video information appliance 104 includes but is not limited to a set top box. The video information appliance 104 can receive the plurality of independent video signals from a cable television signal source 108, a satellite signal source 110, and other wired or wireless sources. The plurality of independent video signals are processed and routed to the electronic device 106. Examples of the electronic device 106 include, but are not limited to, a Television (TV) set, a Personal Digital Assistant (PDA) and a laptop. The electronic device 106 enables the viewing or recording of the processed plurality of independent video signals as per the user instructions.

Though the present invention is explained with the help of the media network 100, it will be apparent to a person skilled in the art that the present invention can also be implemented in any other suitable environment or network.

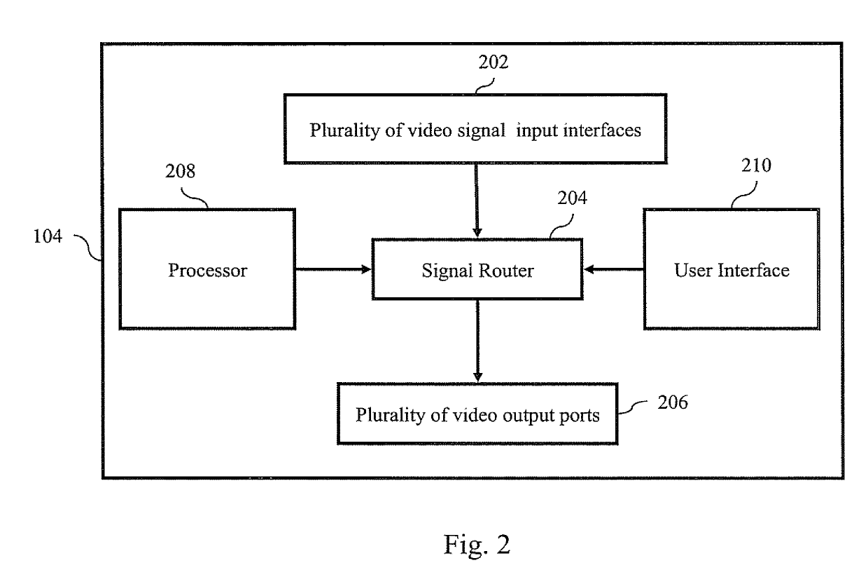

FIG. 2 illustrates a block diagram of the video information appliance 104, in accordance with an embodiment of the present invention. Those ordinarily skilled in the art will understand that the video information appliance 104 may include additional components that are not shown here and are not germane to the operation of video information appliance 104, in accordance with the inventive arrangements. To describe the video information appliance 104, reference will be made to FIG. 1, although it should be understood that the video information appliance 104 can also be implemented in any other suitable environment or network. The video information appliance 104 includes a plurality of video signal input interfaces 202, a signal router 204, a plurality of video output ports 206, a processor 208, and a user interface 210. The plurality of video signal input interfaces 202 is configured to receive the plurality of independent video signals from various signal sources. For example, the plurality of video signal input interfaces 202 receives the plurality of independent video signals from the cable television signal source 108 and the satellite signal source 110. It will be apparent to one skilled in the art that the plurality of video signal input interfaces 202 is shown to receive the plurality of independent video signals from the cable television signal source 108 and the satellite signal source 110 only for exemplary purposes. The plurality of video signal input interfaces 202 can also receive the plurality of independent video signals from media playback device source and over-the-air broadcast television signal source. For example, a first one of the plurality of video signal input interfaces 202 receives an independent video signal from CNN™ and a second one of the plurality of video signal input interfaces 202 receives another independent video signal from HBO™. The plurality of video signal input interfaces 202 are coupled to the signal router 204. The signal router 204 routes the plurality of independent video signals from the plurality of video signal input interfaces 202 to the plurality of video output ports 206. The routing done by the signal router 204 is controlled by the processor 208. The processor 208 is configured to control the signal router 204 by selectively directing at least one of the received independent video signals to at least a first video output port of the plurality of video output ports 206. Further, the processor is configured to control the signal router 204 to selectively direct at least one other of the received plurality of independent video signals to at least a second video output port of the plurality of video output ports 206. In other words, the processor 208 sends the commands to the signal router 204 for selecting and directing the received plurality of independent video signals to the plurality of video output ports 206.

For example, at least one independent video signal from the plurality of independent video signals transmitted by CNN™ is selected and routed by the signal router 204 with the help of the processor 208. Simultaneously, another independent video signal transmitted by the HBO™, is selected and routed by the signal router 204 with the help of the processor 208.

For an embodiment, the selection and routing of the above stated received plurality of independent of video signals is done by the signal router 204 by receiving commands from the user interface 210. For example, a user will feed the commands in the user interface 210 to select and route the received plurality of independent video signals.

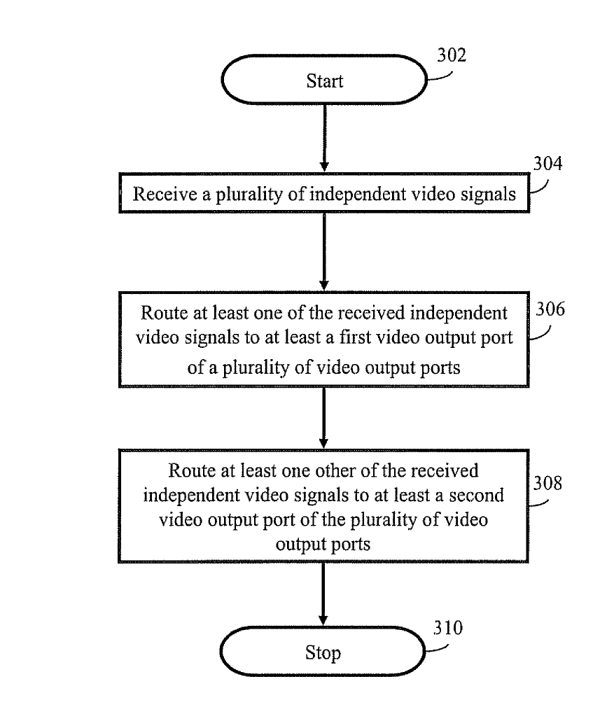

FIG. 3 illustrates a flow chart for routing the plurality of independent video signals within the video information appliance 104, in accordance with an embodiment of the present invention. To describe the method for routing the plurality of independent video signals, reference will be made to FIG. 1 and FIG. 2, although it should be understood that the method can also be implemented in any other suitable environment or network. The method initiates at step 302. At step 304, the plurality of independent video signals is received by the plurality of independent video signal input interfaces 202. For example, the plurality of independent video signals transmitted by the cable television signal source 108 and satellite signal source 110 are received by the plurality of individual independent video signal input interfaces 202. At step 306, at least one of the received plurality of independent video signals is routed to at least the first video output port of the plurality of video output ports 206. In other words, one or more than one of the received plurality of independent video signals is routed to one or more than one of the plurality of video output ports 206. For example, the independent video signal received from the cable television signal source 108 is routed to a first video output port. The signal router 204 routes the at least one of the received plurality of independent video signals by receiving commands from the processor 208. For an embodiment, the signal router 204 routes the at least one of the received plurality of independent video signals by receiving commands from the user interface 210. At step 308, at least one other of the received plurality of independent video signals is routed to the second video output port of the plurality of video output ports 206. For example, the independent video signal received from the satellite signal source 110 is routed to a second video output port. The routing of the independent video signal from the satellite signal source 110 is done in addition to the routing of the independent video signals from the cable television signal source 108. In other words, one or more than one independent video signals from the cable television signal source 108 and satellite signal source 110 can be routed simultaneously to the plurality of video output ports 206. For example, the independent video signal received from HBO™ is simultaneously routed in addition to the routing of the independent video signals from CNN™.

For one embodiment, the routed independent video signals are transmitted by the at least one of the plurality of video output ports 206 to a display device for viewing. The display device decodes and displays the media content of the routed independent signals. Examples of the display device include a television, a lap top, and the like. For another embodiment, the routed independent video signals are transmitted by the at least one of the plurality of video output ports 206 to a video recording device for recording the media content. The video recording device can be a digital recording device, video cassette recording device, and the like. For still another embodiment, the at least one of the plurality of video output ports 206 provides the routed independent video signals to at least one video tuner. The at least one video tuner decodes the media content of the routed independent video signals as per the user requirement. For yet another embodiment, the routed independent video signals is transmitted simultaneously to each of the display device, the video recording device, the at least one tuner, the video decoder. The method terminates at step 310.

Various embodiments of the method and system for routing video signals within a video information appliance have been described above. The video information appliance of the present invention allows the user to view more than one available channel encoded in an independent video signal and simultaneously performing a recording of the other available channels encoded in the independent video signals. Further, the present invention increases the flexibility to route the independent video signals as per user preferences as there is no hardwired connection amongst the circuit elements.

It will be appreciated that the method and system for routing of video signals described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to route the video signals. Alternatively, some or all the functions could be implemented by a state machine that has no stored program instructions, or in one or more application-specific integrated circuits (ASICs), in which each function or some combinations of certain of the functions are implemented as custom logic. Of course, a combination of the two approaches could be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims as issued.

What is claimed is:

1. A video information appliance facilitating routing of a plurality of independent video signals, the video information appliance comprising:
a plurality of video signal input interfaces, each adapted to facilitate the reception of an independent video signal;
a signal router coupled to the plurality of video signal interfaces;
a plurality of video output ports coupled to the signal router; and
a processor adapted to control the signal router to selectively direct at least one of the received independent video signals to at least a first video output port of the plurality of video output ports, and direct at least one other of the received independent video signals to at least a second video output port of the plurality of video output ports.

2. The video appliance of claim 1, wherein the plurality of received independent video signals comprises one or more of the following: an over-the-air broadcast television signal, a cable television signal, a media playback device and a satellite signal.

3. The video appliance of claim 1, wherein at least one of the plurality of video output ports provides a video signal to a display for viewing.

4. The video appliance of claim 1, further comprising
a user interface coupled to the signal router, and wherein the signal router responds to commands received via the user interface to selectively direct at least one of the received independent video signals to at least one of said plurality of video output ports.

5. The video appliance of claim 1, wherein at least one of the plurality of video output ports provides video signal to a video recording device.

6. The video appliance of claim 1, wherein at least one of the plurality of video output ports provides a video signal to at least one video tuner.

7. The video appliance of claim 1, wherein at least one of the plurality of video output ports provides a video signal to at least one video decoder.

8. A method for routing a plurality of independent video signals within a video information appliance, the method comprising:
receiving the plurality of independent video signals, each at an individual video signal input interface;
routing at least one of the received independent video signals to at least a first video output port of a plurality of video output ports; and
routing at least one other of the received independent video signals to at least a second video output port of the plurality of video output ports.

9. The method of claim 8, wherein the received plurality of independent video signals comprise an over-the-air broadcast television signal, a cable television signal, the output from a media playback device and a satellite signal.

10. The method of claim 8, wherein at least one of the plurality of video output ports provides a video signal to a display for viewing.

11. The method of claim 8, wherein at least one of the plurality of video output ports provides video signal to a video recording device.

12. The method of claim 8, wherein at least one of the plurality of video output ports provides a video signal to at least one video tuner.

13. The method of claim 8, wherein at least one of the plurality of video output ports provides a video signal to at least one video decoder.
